(19) United States
(12) Patent Application Publication
(10) Pub. No.: US 2025/0139887 A1
(43) Pub. Date: May 1, 2025

(54) TECHNIQUES FOR DEFINING RELATIONSHIPS BETWEEN OBJECTS WITHIN A USER INTERFACE

(71) Applicant: AUTODESK, INC., San Francisco, CA (US)

(72) Inventors: George William FITZMAURICE, Toronto (CA); Jo Karel VERMEULEN, East York (CA); Justin Frank MATEJKA, Newmarket (CA)

(21) Appl. No.: 18/924,187

(22) Filed: Oct. 23, 2024

Related U.S. Application Data
(60) Provisional application No. 63/593,332, filed on Oct. 26, 2023.

(51) Int. Cl. G06T 17/00; G06F 3/0481; G06F 3/0484; G06F 30/12; G06F 111/04

(52) U.S. Cl. CPC G06T 17/00; G06F 3/0481; G06F 3/0484; G06F 30/12; G06F 2111/04; G06T 2200/04; G06T 2200/24

(57) ABSTRACT

Various embodiments include a computer-implemented method for generating three-dimensional (3D) assemblies, including receiving a relationship input that associates two or more 3D models included in a 3D assembly, receiving a prompt input that includes a portion of text that describes the relationship input, causing a generative machine learning model to generate a design constraint based on the relationship input and the prompt input, and causing the 3D assembly to incorporate the design constraint.

### CROSS-REFERENCE TO RELATED APPLICATIONS

This application claims priority benefit of the United States Provisional Patent Application titled “TECHNIQUES FOR DEFINING RELATIONSHIPS BETWEEN OBJECTS WITHIN A USER INTERFACE,” filed on Oct. 26, 2023, and having Ser. No. 63/593,332. The subject matter of this related application is hereby incorporated herein by reference.

### BACKGROUND

### Field of the Various Embodiments

The various embodiments relate generally to computer-aided design and artificial intelligence and, more specifically, to techniques for defining relationships between objects within a user interface.

### Description of the Related Art

Computer-aided design (CAD) software is widely used in the field of engineering to create three-dimensional (3D) models of mechanical parts and other physical objects. When creating a 3D model for a particular mechanical part, a user interacts with the CAD software to define a set of geometric boundaries that represent the surface and/or volume of that mechanical part within a design space. The 3D model can subsequently be incorporated into a 3D assembly along with other 3D models. For example, when creating a given 3D assembly, the user would interact with the CAD software to position one 3D model relative to another 3D model within the design space.

In a typical use case, the user then interacts with the CAD software to define a set of design constraints that enforce specific conditions on the 3D models included in the 3D assembly. For example, the user could define a dimensional constraint indicating that one 3D model should be located a specific distance away from another 3D model. Alternatively, the user could define a geometric constraint indicating that a surface of one 3D model should remain parallel to a surface of another 3D model. By defining 3D models and design constraints in this manner, the user can cause the 3D assembly to assume a specific physical configuration. Conventional CAD software typically supports a wide range of different types of design constraints that can be implemented in 3D assemblies to define complex relationships between 3D models.

One drawback associated with conventional CAD software, however, is that the user typically needs an advanced level of expertise in order to understand and effectively use the various tools within the CAD software for defining design constraints. Given the wide range of different types of design constraints, the task of selecting and defining a given design constraint correctly to achieve a desired configuration for multiple 3D models can be very difficult for most users. With more complex 3D assemblies that include numerous 3D models, the task of selecting and defining the many different types of design constraints needed is often intractable for all but the most advanced users.

Another drawback associated with conventional CAD software is that the user sometimes lacks the particular engineering knowledge needed to define valid design constraints for a given 3D assembly. For example, the user may need to generate a 3D assembly that provides a standard clearance between two parts, but the user may not know that the standard clearance is needed, or may not know what the specific value of the standard clearance is. Consequently, the user can inadvertently create a 3D assembly that does not meet design specifications or cannot be readily manufactured.

Yet another drawback associated with conventional CAD software is that some design constraints associated with a complex 3D assembly can unexpectedly become invalid when other design constraints are modified or the 3D models included in the 3D assembly are modified. For example, a distance constraint between two 3D models may become impossible to satisfy if the size of one of those 3D models is reduced beyond a certain threshold. In complex 3D assemblies with numerous design constraints, even small changes can end up propagating throughout the 3D assembly, rendering numerous design constraints invalid. Analyzing and correcting each individual design constraint in such situations is extremely difficult and tedious, and most users simply lack the requisite level of expertise to correct these issues, resulting in 3D assemblies that cannot be physically built and/or manufactured.

As the foregoing illustrates, what is needed in the art are more effective techniques for generating 3D assemblies in CAD applications.

### SUMMARY

Various embodiments include a computer-implemented method for generating three-dimensional (3D) assemblies, including receiving a relationship input that associates two or more 3D models included in a 3D assembly, receiving a prompt input that includes a portion of text that describes the relationship input, causing a generative machine learning model to generate a design constraint based on the relationship input and the prompt input, and causing the 3D assembly to incorporate the design constraint.

At least one technical advantage of the disclosed techniques relative to the prior art is that the disclosed techniques enable generative ML models to automatically translate generic descriptions of relationships between the 3D models included in a 3D assembly into concrete design constraints that can be enforced on those 3D models. Accordingly, a user is not required to have an advanced level of expertise in order to generate complex 3D assemblies that involve a large number of 3D models and relationships between those 3D models. Another technical advantage of the disclosed techniques is that design constraints can be generated in a manner that accommodates various design specifications relevant to the physical manufacture of the 3D assembly. The user is therefore not required to account for certain engineering and/or manufacturing considerations when designing the 3D assembly. Yet another technical advantage of the disclosed techniques is that the design constraints can be automatically updated in response to modifications to the 3D assembly. As such, situations where small changes to the 3D assembly render different design constraints invalid can be largely avoided. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the design generation application and the constraint generation application of FIG. 1, according to various embodiments;

FIGS. 3A-3C are exemplar illustrations showing how the constraint generation application of FIG. 2 generates design constraints for a 3D assembly, according to various embodiments;

FIG. 4 sets forth a flow diagram of method steps for generating and updating a design constraint for a 3D assembly based on a user-defined relationship, according to various embodiments; and

FIG. 5 depicts one architecture of a system within which the various may be implemented.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

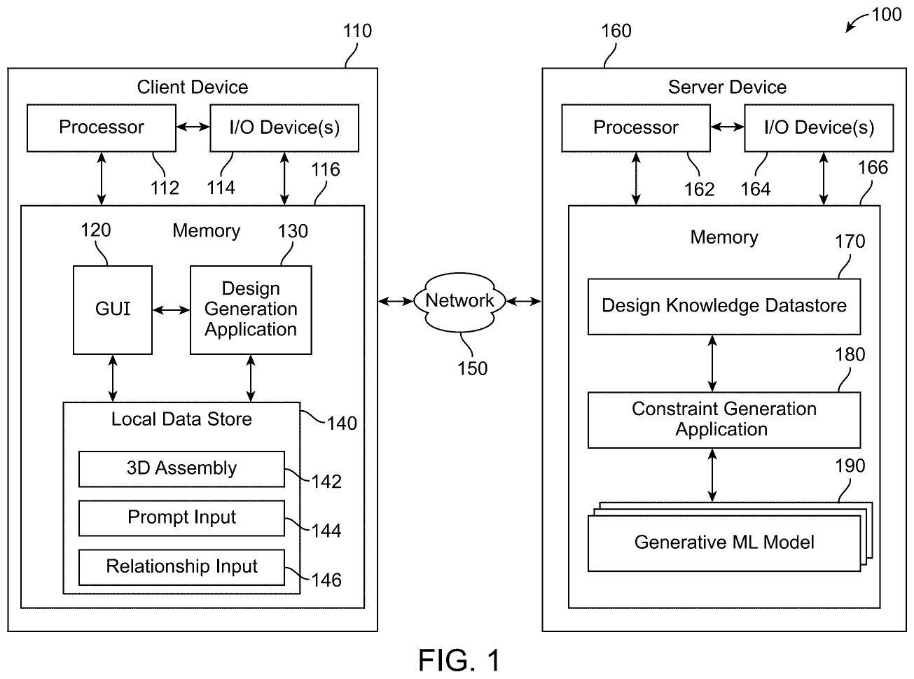

FIG. 1 is a conceptual illustration of a system 100 configured to implement one or more aspects of the various embodiments. As shown, in some embodiments, the system 100 includes, without limitation, a client device 110 and a server device 160. The client device 110 includes, without limitation, a processor 112, one or more input/output (I/O) devices 114, and a memory 116. The memory 116 includes, without limitation, a graphical user interface (GUI) 120, a design generation application 130, and a local data store 140. The local data store 140 includes, without limitation, a three-dimensional (3D) assembly 142, prompt input 144, and relationship input 146. The server device 160 includes, without limitation, a processor 162, one or more I/O devices 164, and a memory 166. The memory 166 includes, without limitation, a design knowledge datastore 170, a constraint generation application 180, and at least one generative ML model 190. In some other embodiments, the system 100 can include any number and/or types of other client devices, server devices, additional ML models, or any combination thereof.

Any number of the components of the system 100 can be distributed across multiple geographic locations or implemented in one or more cloud computing environments (e.g., encapsulated shared resources, software, data) in any combination. In some embodiments, the client device 110 and/or zero or more other client devices (not shown) can be implemented as one or more compute instances in a cloud computing environment, implemented as part of any other distributed computing environment, or implemented in a stand-alone fashion. In various embodiments, the client device 110 can be integrated with any number and/or types of other devices (e.g., one or more other compute instances and/or a display device) into a user device. Some examples of user devices include, without limitation, desktop computers, laptops, smartphones, and tablets.

In general, the client device 110 is configured to implement one or more software applications. For explanatory purposes only, each software application is described as residing in the memory 116 of the client device 110 and executing on the processor 112 of the client device 110. In some embodiments, any number of instances of any number of software applications can reside in the memory 116 and any number of other memories associated with any number of other compute instances and execute on the processor 112 of the client device 110 and any number of other processors associated with any number of other compute instances in any combination. In the same or other embodiments, the functionality of any number of software applications can be distributed across any number of other software applications that reside in the memory 116 and any number of other memories associated with any number of other compute instances and execute on the processor 112 and any number of other processors associated with any number of other compute instances in any combination. Further, subsets of the functionality of multiple software applications can be consolidated into a single software application.

In particular, the client device 110 is configured to implement a design generation application 130 that allows a user to generate and/or modify the 3D assembly 142. In various embodiments, the 3D assembly includes a collection of 3D models, where each 3D model is defined by 3D geometry. The design generation application 130 is configured to interact with a user via the GUI 120, and in doing so, receives commands from the user that define the placement and positioning of 3D models within the 3D assembly 142. The design generation application 130 is further configured to obtain a prompt input 144 and a relationship input 146 from the user. The relationship input 146 associates at least two 3D models included in the 3D assembly 142 with one another. The prompt input 144 is a text-based description of the relationship between those 3D models. Based on the prompt input 144 and the relationship input 146, the constraint generation application 180 generates design constraints for the 3D assembly 142, as described in greater detail below.

In various embodiments, the processor 112 can be any instruction execution system, apparatus, or device capable of executing instructions. For example, the processor 112 could comprise a central processing unit (CPU), a digital signal processing unit (DSP), a microprocessor, an application-specific integrated circuit (ASIC), a neural processing unit (NPU), a graphics processing unit (GPU), a field-programmable gate array (FPGA), a controller, a microcontroller, a state machine, or any combination thereof. In some embodiments, the processor 112 is a programmable processor that executes program instructions to manipulate input data. In some embodiments, the processor 112 can include any number of processing cores, memories, and other modules for facilitating program execution.

The input/output (I/O) devices 114 include devices configured to receive input, including, for example, a keyboard, a mouse, and so forth. In some embodiments, the I/O devices 114 also includes devices configured to provide output, including, for example, a display device, a speaker, and so forth. Additionally or alternatively, the I/O devices 114 may further include devices configured to both receive and provide input and output, respectively, including, for example, a touchscreen, a universal serial bus (USB) port, and so forth.

The memory 116 includes a memory module, or collection of memory modules. In some embodiments, the memory 116 can include a variety of computer-readable media selected for their size, relative performance, or other capabilities: volatile and/or non-volatile media, removable and/or non-removable media, etc. The memory 116 can include cache, random access memory (RAM), storage, etc. The memory 116 can include one or more discrete memory modules, such as dynamic RAM (DRAM) dual inline memory modules (DIMMs). Of course, various memory chips, bandwidths, and form factors may alternately be selected. The memory 116 stores content, such as software applications and data, for use by the processor 112. In some embodiments, a storage (not shown) supplements or replaces the memory 116. The storage can include any number and type of external memories that are accessible to the processor 112 of the client device 110. For example, and without limitation, the storage can include a Secure Digital (SD) Card, an external Flash memory, a portable compact disc read-only memory, an optical storage device, a magnetic storage device, or any suitable combination of the foregoing.

Non-volatile memory included in the memory 116 generally stores one or more application programs including the design generation application 130, and data (e.g., the design data 142, the prompt input 144, and the relationship input 146 stored in the local data store 140) for processing by the processor 112. In various embodiments, the memory 116 can include non-volatile memory, such as optical drives, magnetic drives, flash drives, or other storage. In some embodiments, separate data stores, such as one or more external data stores connected via the network 150 (“cloud storage”) can supplement the memory 116. In various embodiments, the design generation application 130 within the memory 116 can be executed by the processor 112 to implement the overall functionality of the client device 110 to coordinate the operation of the system 100 as a whole.

In various embodiments, the memory 116 can include one or more modules for performing various functions or techniques described herein. In some embodiments, one or more of the modules and/or applications included in the memory 116 may be implemented locally on the client device 110, and/or may be implemented via a cloud-based architecture. For example, any of the modules and/or applications included in the memory 116 could be executed on a remote device (e.g., smartphone, a server system, a cloud computing platform, etc.) that communicates with the client device 110 via a network interface or an I/O devices interface.

The design generation application 130 resides in the memory 116 and executes on the processor 112 of the client device 110. The design generation application 130 interacts with the user via the GUI 120, as mentioned. In some embodiments, the design generation application 130 and one or more separate applications (not shown) interact with the same user via the GUI 120. In various embodiments, the design generation application 130 interacts with the user via the GUI 120 to display the 3D assembly 142 and/or 3D models included therein.

The GUI 120 receives the prompt input 144 and the relationship input 146 from the user via a prompt space and a design space, respectively, that are included in the GUI 120. The prompt space is configured to receive the prompt input 144 as text input, though in some embodiments the prompt space may receive multi-modal prompt inputs. The design space is configured to receive the relationship input 146 as a user selection of two or more 3D models and/or two or more portions of 3D models. In one embodiment, the relationship input 146 may include a selection of a region of the design space, where that region may include one or more 3D models and/or one or more portions of 3D models. The prompt input 144 generally includes a text-based description of a desired relationship between the 3D models (or portions thereof) that are associated with one another via the relationship input 146. The design generation application 130 is configured to obtain the prompt input 144 and the relationship input 146 and then interoperate with the constraint generation application 180 to generate design constraints for the 3D assembly 142.

The GUI 120 can be any type of user interface that allows users to interact with one or more software applications via any number and/or types of GUI elements. The GUI 120 can be displayed in any technically feasible fashion on any number and/or types of stand-alone display device, any number and/or types of display screens that are integrated into any number and/or types of user devices, or any combination thereof. The design generation application 130 can perform any number and/or types of operations to directly and/or indirectly display and monitor any number and/or types of interactive GUI elements and/or any number and/or types of non-interactive GUI elements within the GUI 120. In some embodiments, each interactive GUI element enables one or more types of user interactions that automatically trigger corresponding user events. Some examples of types of interactive GUI elements include, without limitation, scroll bars, buttons, text entry boxes, drop-down lists, and sliders. In some embodiments, the design generation application 130 organizes GUI elements into one or more container GUI elements (e.g., panels and/or panes).

The network 150 can be any technically feasible set of interconnected communication links, including a local area network (LAN), wide area network (WAN), the World Wide Web, or the Internet, among others. The network 150 enables communications between the client device 110 and other devices in the network 150 via wired and/or wireless communications protocols, including Bluetooth, Bluetooth low energy (BLE), wireless local area network (WiFi), cellular protocols, satellite networks, and/or near-field communications (NFC).

The server device 160 is configured to communicate with the design generation application 130 to process the prompt input 144 and the relationship input 146. In operation, the server device 160 executes the constraint generation application 180 to generate one or more design constraints based on the prompt input 144, the relationship input 146, and the design knowledge datastore 170. The design knowledge datastore 170 includes a variety of different types of engineering data and design specifications, including, for example and without limitation, engineering standards, material dimensions, manufacturing data, and so forth. The design knowledge datastore 170 can also include engineering data specific to a given team, product line, or company. For example, and without limitation, the design knowledge datastore 170 could include a tabulation of material properties for a specific type of lubrication that is used by a given company for a particular model of ball bearing.

In various embodiments, the processor 162 can be any instruction execution system, apparatus, or device capable of executing instructions. For example, the processor 162 could comprise a central processing unit (CPU), a digital signal processing unit (DSP), a microprocessor, an application-specific integrated circuit (ASIC), a neural processing unit (NPU), a graphics processing unit (GPU), a field-programmable gate array (FPGA), a controller, a microcontroller, a state machine, or any combination thereof. In some embodiments, the processor 162 is a programmable processor that executes program instructions to manipulate input data. In some embodiments, the processor 162 can include any number of processing cores, memories, and other modules for facilitating program execution.

The input/output (I/O) devices 164 include devices configured to receive input, including, for example, a keyboard, a mouse, and so forth. In some embodiments, The I/O devices 164 also includes devices configured to provide output, including, for example, a display device, a speaker, and so forth. Additionally or alternatively, the I/O devices 164 may further include devices configured to both receive and provide input and output, respectively, including, for example, a touchscreen, a universal serial bus (USB) port, and so forth.

The memory 166 includes a memory module, or collection of memory modules. In some embodiments, the memory 166 can include a variety of computer-readable media selected for their size, relative performance, or other capabilities: volatile and/or non-volatile media, removable and/or non-removable media, etc. The memory 166 can include cache, random access memory (RAM), storage, etc. The memory 166 can include one or more discrete memory modules, such as dynamic RAM (DRAM) dual inline memory modules (DIMMs). Of course, various memory chips, bandwidths, and form factors may alternately be selected. The memory 166 stores content, such as software applications and data, for use by the processor 162. In some embodiments, a storage (not shown) supplements or replaces the memory 166. The storage can include any number and type of external memories that are accessible to the processor 162 of the server device 160. For example, and without limitation, the storage can include a Secure Digital (SD) Card, an external Flash memory, a portable compact disc read-only memory, an optical storage device, a magnetic storage device, or any suitable combination of the foregoing.

Non-volatile memory included in the memory 166 generally stores one or more application programs including the constraint generation application 180 and the generative ML model(s) 190, and data (e.g., the prompt catalog 170) for processing by the processor 112. In various embodiments, the memory 166 can include non-volatile memory, such as optical drives, magnetic drives, flash drives, or other storage. In some embodiments, separate data stores, such as one or more external data stores connected via the network 150 can supplement the memory 166. In various embodiments, the constraint generation application 180 and/or the generative ML models 190 within the memory 166 can be executed by the processor 162 to implement the overall functionality of the server device 160 to coordinate the operation of the system 100 as a whole.

In various embodiments, the memory 166 can include one or more modules for performing various functions or techniques described herein. In some embodiments, one or more of the modules and/or applications included in the memory 166 may be implemented locally on the client device 110, the server device 160, and/or may be implemented via a cloud-based architecture. For example, any of the modules and/or applications included in the memory 166 could be executed on a remote device (e.g., smartphone, a server system, a cloud computing platform, etc.) that communicates with the server device 160 via a network interface or an I/O devices interface. Additionally or alternatively, the constraint generation application 180 could be executed on the client device 110 and can communicate with the generative ML model(s) 190 operating at the server device 160.

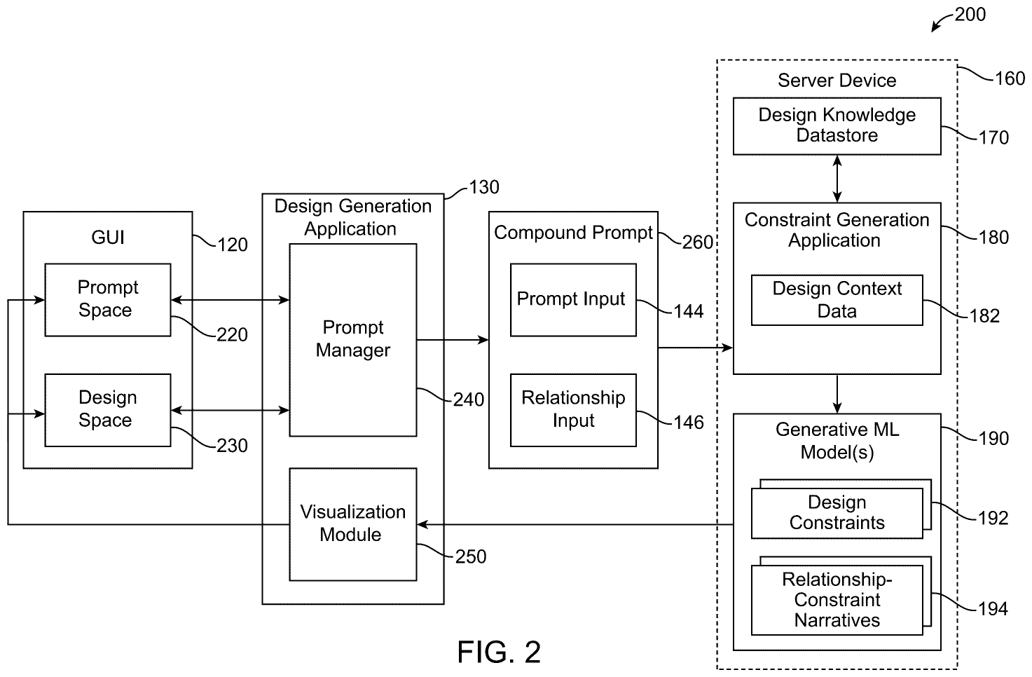

In various embodiments, the constraint generation application 180 receives the prompt input 144 and the relationship input 146 from the design generation application 130 and then accesses the design knowledge datastore 170 to retrieve design context data. The design context data is contextually-relevant engineering data and may include a variety of parametric values that can be used to constrain various aspects of the 3D geometry included in the 3D assembly. In one embodiment, the constraint generation application 180 may also access the design knowledge data store 170 based on the 3D assembly 142 or any portion thereof to extract the design context data. The constraint generation application 180 inputs the prompt input 144, the relationship input 146, and the design context data to the generative ML model 190. In response, the generative ML model 190 generates design constraints, as mentioned above and described in greater detail below in conjunction with FIG. 2.

In some embodiments, one or more of the generative ML model(s) 190 are trained to respond to specific types of inputs, such as an ML model that is trained to generate text-based responses from a specific combination of modalities (e.g., text and images). In such instances, the constraint generation application 180 processes various inputs to determine the modalities of the data included therein and identifies one or more of the ML model(s) 190 that have been trained to respond to such a combination of modalities. Upon identifying the one or more ML models 190, the constraint generation application 180 selects an ML model and inputs the prompt into the selected ML model 190.

The generative ML model(s) 190 include one or more ML models that have been trained on a relatively large amount of existing data to perform any number and/or types of prediction tasks based on patterns detected in the existing data. In some embodiments, a given trained ML model 190 is trained using various combinations of data from multiple modalities, such as textual data, image data, sound data, and so forth. The generative ML model(s) 190 that are trained using at least two modalities of data are also referred to herein as multimodal ML model(s). For example, in some embodiments, one or more trained ML models 190 can include a third-generation Generative Pre-Trained Transformer (GPT-3) model, a specialized version of a GPT-3 model referred to as a “DALL-E2” model, a fourth-generation Generative Pre-Trained Transformer (GPT-4) model, and so forth.

### Defining Relationships Between Objects Within a User Interface

FIG. 2 is a more detailed illustration of the design generation application 130 and the constraint generation application 180 of FIG. 1, according to various embodiments. As shown, in some embodiments, a system 200 includes, without limitation, the GUI 120, the design generation application 130, and the server device 160. The GUI 120 includes, without limitation, a prompt space 220 and a design space 230. The design generation application 130 includes, without limitation, a prompt manager 240 and a visualization module 250. The server device 160 includes, without limitation, the engineering knowledge datastore 170, the constraint generation application 180, and at least one generative ML model 190.

For explanatory purposes only, the functionality of the design generation application 130 and the constraint generation application 180 is described herein in the context of exemplar interactive and linear workflows. As persons skilled in the art will recognize, the techniques described herein are illustrative rather than restrictive and can be altered and applied in other contexts without departing from the broader spirit and scope of the inventive concepts described herein.

In operation, the visualization module 250 generates the GUI 120, including the prompt space 220 and the design space 230. The prompt space 220 generally includes GUI elements for receiving text input, although in some embodiments the prompt space 220 may also receive multi-modal inputs. The design space 230 generally includes GUI elements for generating, manipulating, and displaying the 3D assembly 142. The design space 230 also includes GUI elements that allow the user to select portions of the 3D assembly 142, including a cursor, among others. The prompt manager 240 interacts with the prompt space 220 to obtain the prompt input 144 from the user. The prompt manager 240 also interacts with the design space 230 to obtain the relationship input 146, including selections of specific portions of the 3D assembly 142 and/or selections of various 3D models included in the 3D assembly 142.

The relationship input 146 represents an association between two or more 3D models included in the 3D assembly (or portions thereof) that is described, at some level of detail, by the prompt input 144. In practice, the user specifies the relationship input 146 via interactions with the GUI 120, and then inputs the prompt input 144 to describe one or more conditions that should be met by the 3D models referenced by the relationship input 146. For example, and without limitation, the relationship input 146 could indicate a first edge of one 3D model and a second edge of another 3D model, and the corresponding prompt input 144 could include the text “the first edge should always be parallel to the second edge.” The constraint generation application 180 is configured to transform prompt inputs and relationship inputs such as these into concrete design constraints that can be interpreted by the design generation application 130.

The prompt manager 240 generates a compound prompt 260 to include both the prompt input 144 and the relationship input 146. In one embodiment, the compound prompt 260 may be a multi-modal prompt that includes data associated with two distinct modalities. For example, and without limitation, the prompt input 144 could include text, while the relationship input 146 could include 3D geometry, one or more images, and so forth. The constraint generation application 180 is configured to access the design knowledge datastore 170, based on the compound prompt 260 and/or data included therein, in order to extract the design context data 182. The design context data 182 includes various parameters that are contextually relevant to the 3D assembly. In one embodiment, the design knowledge datastore 170 may be a generative ML model that is trained to generate various types of design context data based on multi-modal inputs that reflect 3D assemblies.

The constraint generation application 180 then causes the generative ML model 190 to generate one or more design constraints 192 and one or more corresponding relationship-constraint narratives 194 based on the prompt input 144 and the relationship input 146 included in the multimodal prompt 260 as well as the design context data 182 extracted from the design knowledge data store 170. A given design constraint 192 is a computer-readable expression that represents a geometric and/or dimensional condition that should be satisfied by the 3D assembly 142. When the condition is met, the design generation application 130 considers the 3D assembly 142 to be fully constrained and therefore valid. If the condition is not met, then the design generation application 130 considers the 3D assembly to be invalid. The design generation application 130 is configured to analyze multiple design constraints 192 and to then modify the 3D assembly automatically 142 in order to bring the 3D assembly 142 into compliance with those design constraints, thereby causing the 3D assembly 142 to be considered valid.

A given relationship-constraint narrative 194 is a text-based description that describes how a corresponding design constraint 192 accomplishes the relationship expressed by the user via the prompt input 144 and the relationship input 146. Each relationship-constraint narrative 194 may further include descriptive text that explains how the design context data 182 informs the generation of a corresponding design constraint 192 and why the accommodation of the design context data 182 is relevant to constraining the 3D assembly 142. In various embodiments, a relationship-constraint narrative 194 may provide a mechanism through which the user can interact with the generative ML model 190 and make adjustments to the design constraints 192, as needed. The visualization module 250 is configured to update the GUI 120 based on the design constraints 192 and the relationship-constraint narratives 194.

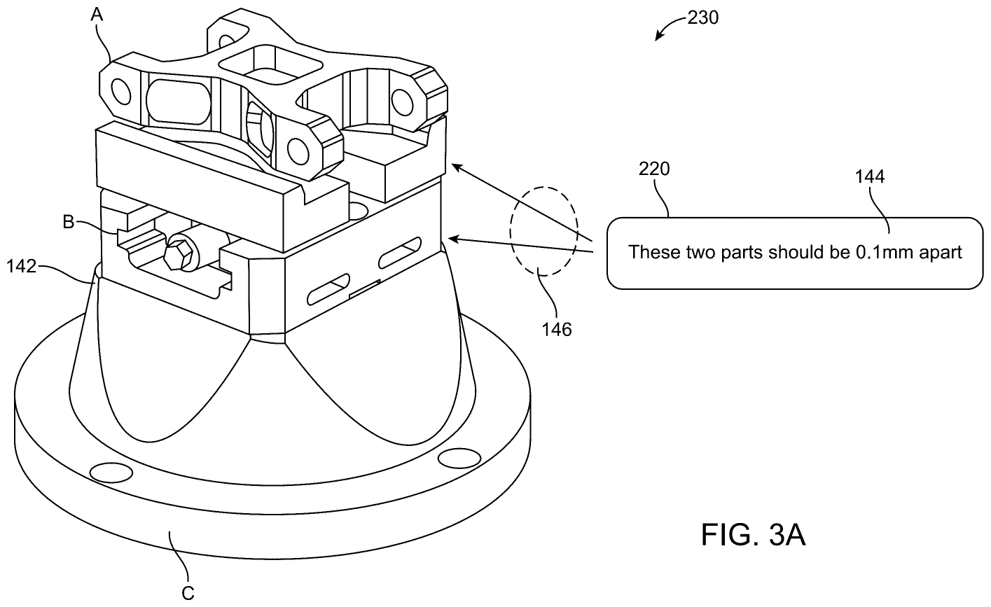

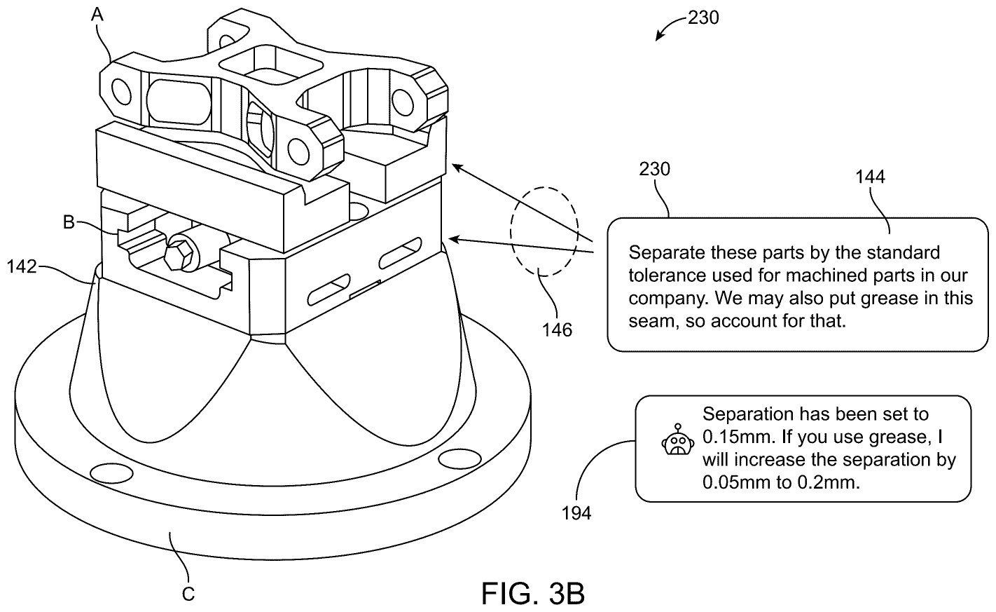

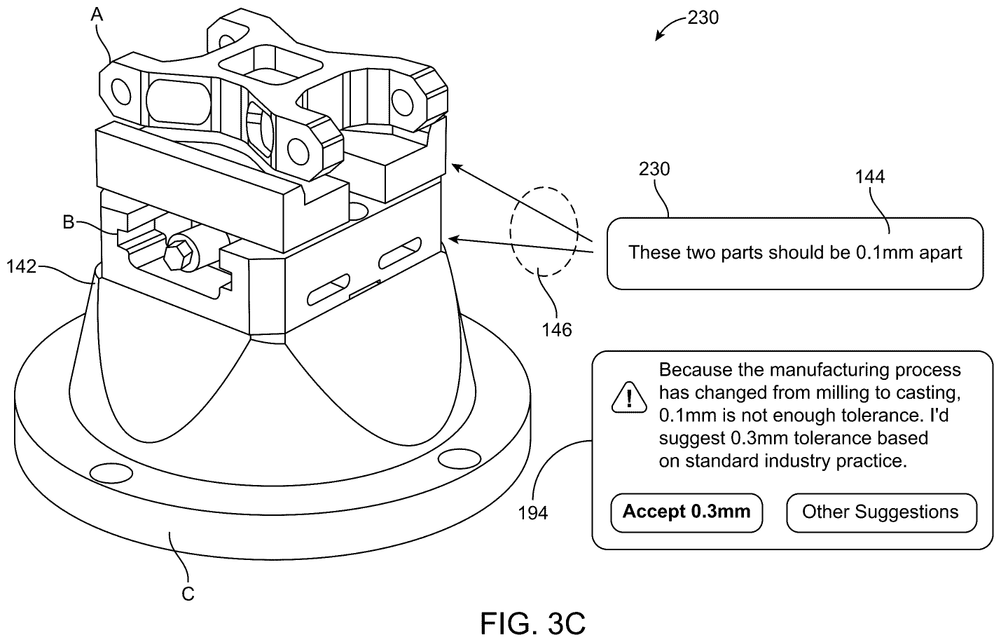

FIGS. 3A-3C are exemplar illustrations of how the constraint generation application of FIG. 2 generates design constraints for a 3D assembly, according to various embodiments. As shown in FIG. 3A, the design space 230 includes the 3D assembly 142. The 3D assembly 142, in turn, includes various 3D models A, B, and C positioned within the design space 230 relative to one another. As also shown, the design space 230 includes the relationship input 146. Here, the relationship input 146 represents an association between 3D model A and 3D model B. As also shown, the prompt space 220 includes the prompt input 144. In this example, the prompt input 144 describes a condition that is satisfied when 3D models A and B are positioned a specific distance from one another. In practice, the user implements various tools provided by GUI 120 to generate the relationship input 146 and to provide the prompt input 144.

In response to the prompt input 144 and the relationship input 146, the constraint generation application 180 causes the generative ML model 190 to generate a design constraint 192 (not shown here) that, when enforced by the design generation application 130, causes 3D models A and B to have the desired separation. In one embodiment, the design generation application 130 may implement one or more multivariable optimization algorithms in order to adjust the 3D assembly 142 so that the design constraint 192 is met. In addition, the constraint generation application 180 causes the generative ML model 190 to generate the relationship-constraint narrative 194. The relationship-constraint narrative 194 in the example shown describes what constraint was added and what effect that constraint has on the 3D assembly 142. The constraint generation application 190 can also generate design constraints 192 and relationship-constraint narratives 194 based on the design context data 182, as described below in conjunction with FIGS. 3B-3C.

As shown in FIG. 3B, the exemplary prompt input 144 expresses a need for parts A and B to be separated from one another, but the specific distance of that separation is not provided in the prompt input 144. However, the prompt input 144 references a standard tolerance, and so the constraint generation application 180 can access the design knowledge datastore 170 to determine a specific value for the standard tolerance. Similarly, the prompt input 144 references a possible need to add lubrication, and so the constraint generation application 180 can further access the design knowledge datastore 170 to determine a set of material properties associated with that lubrication. Based on the design context data 182 determined in this manner, the constraint generation application 180 can then cause the generative ML model 190 to generate design constraints 192 that accommodate these additional design considerations. Further, the constraint generation application 180 can also cause the generative ML model 190 to generate the relationship-constraint narrative 194 to describe how and why these accommodations are needed. In the example shown, the relationship-constraint narrative 194 explains that the distance constraint is set to the specific standard tolerance needed, and that additional changes may be needed to accommodate lubrication having specific material properties. Constraint generation application 180 can also respond to changes to 3D assembly 142, as described below in conjunction with FIG. 3C.

As shown in FIG. 3C, the exemplary prompt input 144 expresses a need for parts A and B to be separated from one another by a specific distance. In addition, the relationship-constraint narrative 194 indicates that a manufacturing process associated with 3D assembly 142 and/or the various 3D models included therein has changed. Changes of this nature are common in 3D design and oftentimes cause 3D assemblies to become invalid. However, the constraint generation engine 180 is configured to automatically respond to such changes and to then generate updated design constraints 192 that, when enforced by the design generation application 130, render the 3D assembly 142 a valid design. In so doing, the constraint generation application 180 may access the design knowledge datastore 170 to obtain design context data 182 indicating the specific industry-standard tolerance needed to support the updated manufacturing process. The relationship-constraint narrative 194 shown describes the modification to the design constraints 192 that are needed to accommodate the change in manufacturing process. In this manner, the design generation application 130 and the constraint generation application 180 interoperate to respond to changes in the 3D assembly 142. Referring generally to FIGS. 3A-3C, the techniques described herein by way of example advantageously allow users to generate and manipulate highly complex 3D assemblies expeditiously and with limited expertise.

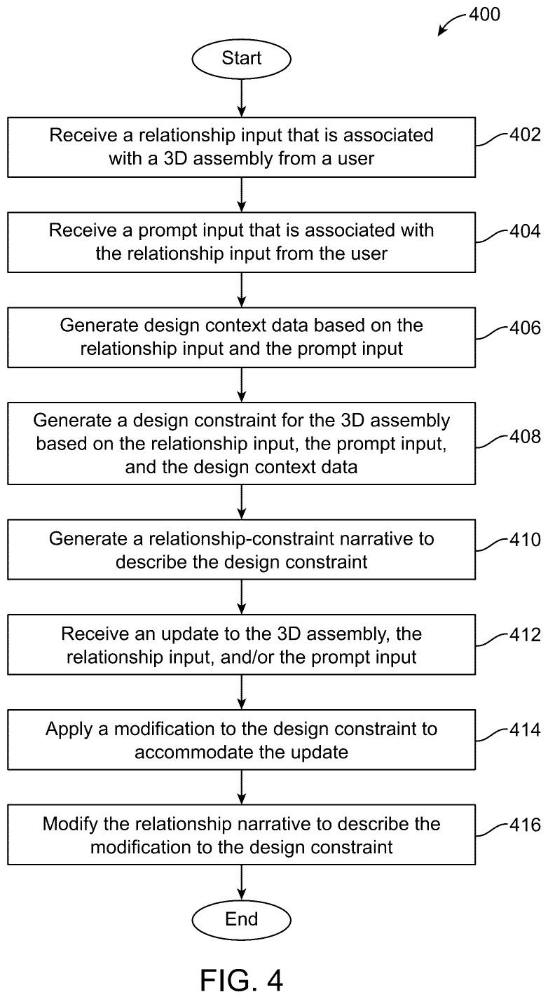

FIG. 4 sets forth a flow diagram of method steps for generating a prompt modification and a design modification based on a catalog of prompts, according to various embodiments. Although the method steps are described with reference to the systems of FIGS. 1-3C, persons skilled in the art will understand that any system configured to implement the method steps, in any order, falls within the scope of the embodiments.

As shown, a method 400 begins at step 402, where the design generation engine 130 receives a relationship input 146 that is associated with a 3D assembly 142 from a user. The design generation engine 130 receives the relationship input 146 via the design space 230 included in the GUI 120. The relationship input 146 includes a selection of two or more 3D models and/or two or more portions of 3D models included in the 3D assembly 142. In one embodiment, the relationship input 146 may include a selection of a region of the design space 230, where that region may include one or more 3D models and/or one or more portions of 3D models.

At step 404, the design generation engine 130 receives a prompt input 144 that is associated with the relationship input 146 from the user. The prompt input 144 generally includes a text-based description of a desired relationship between the 3D models (or portions thereof) that are associated with one another via the relationship input 146. The design generation application 130 is configured to obtain the prompt input 144 via the prompt space 220 included in the GUI 120.

At step 406, the constraint generation engine 180 generates the design context data 182 based on the relationship input 146 and the prompt input 144. The design context data 182 is contextually-relevant engineering data and may include a variety of parametric values that can be used to constrain various aspects of the 3D assembly 142. In one embodiment, the constraint generation application 180 may also access the design knowledge data store 170 based on the 3D assembly 142 or any portion thereof to extract the design context data 182.

At step 408, the constraint generation engine 180 causes the generative ML model 190 to generate a design constraint 192 for the 3D assembly 142 based on the relationship input 146, the prompt input 144, and the design context data 182. A given design constraint 192 is a computer-readable expression that represents a geometric and/or dimensional condition that should be satisfied by the 3D assembly 142. When the condition is met, the design generation application 130 considers the 3D assembly 142 to be fully constrained and therefore valid. If the condition is not met, then the design generation application 130 considers the 3D assembly to be invalid. The design generation application 130 is configured to analyze multiple design constraints 192 and to then automatically modify the 3D assembly 142 in order to bring the 3D assembly 142 into compliance with those design constraints.

At step 410, the constraint generation engine 180 causes the generative ML model 190 to generate a relationship-constraint narrative 194 to describe the design constraint 192. A given relationship-constraint narrative 194 is a text-based description that describes how a corresponding design constraint 192 implements the relationship expressed by the user via the prompt input 144 and the relationship input 146. Each relationship-constraint narrative 194 may further include descriptive text that explains how the design context data 182 informs the generation of a corresponding design constraint 192 and why the accommodation of the design context data 182 is relevant to constraining the 3D assembly 142. In various embodiments, a relationship-constraint narrative 194 may provide a mechanism through which the user can interact with the generative ML model 190 and make adjustments to the design constraints 192, as described above in conjunction with FIG. 3C.

At step 412, the design generation application 130 receives an update to the 3D assembly 142, the relationship input 146, and/or the prompt input 144. During design of a 3D assembly, changes of this nature are common and can potentially cause 3D assemblies to need modification. For example, and without limitation, suppose a dimensional constraint indicates that two 3D models should be a given distance apart, but the addition of a third 3D model prevents this condition from being met.

At step 414, the constraint generation application 180 causes the generative ML model 190 to apply a modification to the design constraint 192 to accommodate the update. In so doing, the constraint generation application 180 may analyze the 3D assembly 142 and generate a new design constraint 192 that the 3D assembly 142 can satisfy or be modified to satisfy. Returning to the above example, without limitation, the constraint generation application 180 could update the dimensional constraint to indicate that the two 3D models should be a larger distance apart, thereby accommodating the addition of the third 3D model. The constraint generation application 180 can implement the design context data 182 in generating and/or updating design constraints 192.

At step 416, the constraint generation application 180 causes the generative ML model 190 to modify the constraint-relationship narrative 194 to describe the modification to the design constraint. In one embodiment, the constraint-relationship narrative 194 includes interactive GUI elements that allow the user to select between different possible modifications to the design constraints 192, as described by way of example in conjunction with FIG. 3C.

### System Implementation

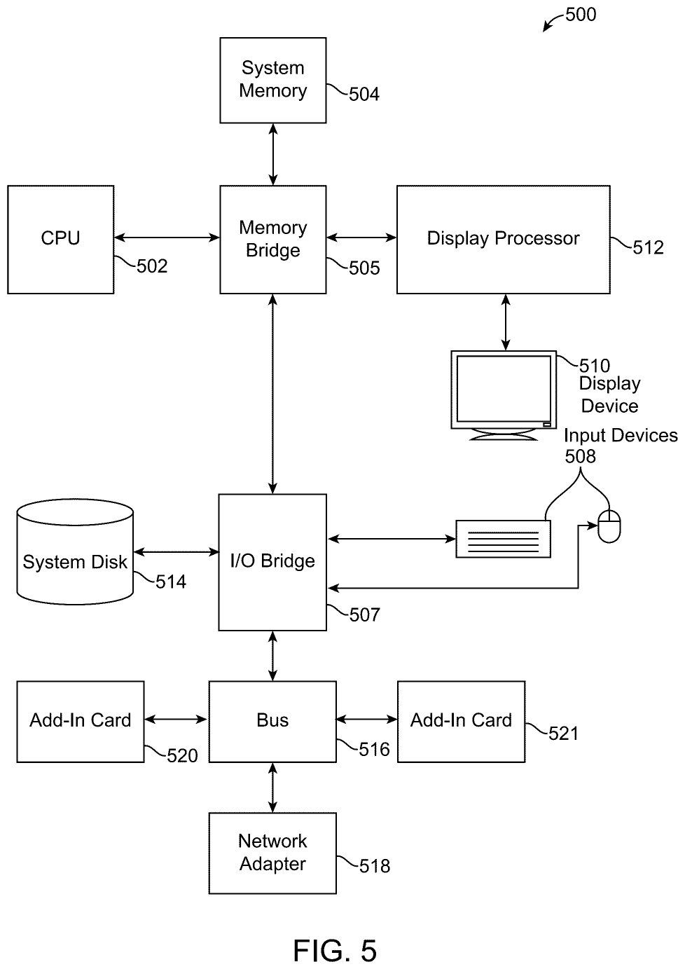

FIG. 5 depicts one architecture of a system 500 within which embodiments of the present disclosure may be implemented. This figure in no way limits or is intended to limit the scope of the present disclosure. In various implementations, system 500 may be an augmented reality, virtual reality, or mixed reality system or device, a personal computer, video game console, personal digital assistant, mobile phone, mobile device, or any other device suitable for practicing one or more embodiments of the present disclosure. Further, in various embodiments, any combination of two or more systems 500 may be coupled together to practice one or more aspects of the present disclosure.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or HyperTransport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 5110 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces set forth in Appendices A-J, attached hereto, are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments of the present disclosure, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 1. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, a design generation application generates a three-dimensional (3D) assembly based on interactions between a user and a graphical user interface (GUI). The design generation application receives a relationship input from the user that indicates a relationship between two or more 3D models included in the 3D assembly. The design generation application also receives a prompt input from the user that includes a description of that relationship. A constraint generation application analyzes the relationship input and the prompt input in conjunction with the 3D assembly and extracts design context data from a design knowledge datastore. The design context data includes various design specifications that may be relevant to the physical manufacturing of the 3D assembly, including machining tolerances, material thickness parameters, and lubrication properties, among others.

The constraint generation application then causes a generative machine learning (ML) model to analyze the relationship input, the prompt input, and the design context data in order to generate one or more design constraints for the 3D assembly. A given design constraint represents a parametric condition that the design generation application enforces on 3D models included in the 3D assembly. The constraint generation application also generates a relationship-constraint narrative that includes descriptive text that explains how the design constraint satisfies the user-defined relationship set forth by the relationship input and the prompt input. The constraint generation application provides the design constraint to the design generation application, and the design generation application in turn modifies the 3D assembly to satisfy the design constraint. The constraint generation application also provides the relationship-constraint narrative to the GUI for display to the user in conjunction with the modified 3D assembly.

At least one technical advantage of the disclosed techniques relative to the prior art is that the disclosed techniques enable generative ML models to automatically translate generic descriptions of relationships between the 3D models included in a 3D assembly into concrete design constraints that can be enforced on those 3D models. Accordingly, a user is not required to have an advanced level of expertise in order to generate complex 3D assemblies that involve a large number of 3D models and relationships between those 3D models. Another technical advantage of the disclosed techniques is that design constraints can be generated in a manner that accommodates various design specifications relevant to the physical manufacture of the 3D assembly. The user is therefore not required to account for certain engineering and/or manufacturing considerations when designing the 3D assembly. Yet another technical advantage of the disclosed techniques is that the design constraints can be automatically updated in response to modifications to the 3D assembly. As such, situations where small changes to the 3D assembly render different design constraints invalid can be largely avoided. These technical advantages provide one or more technological advancements over prior art approaches

Any and all combinations of any of the claim elements recited in any of the claims and/or any elements described in this application, in any fashion, fall within the contemplated scope of the present invention and protection.

1. Some embodiments include a computer-implemented method for generating three-dimensional (3D) assemblies, the method comprising receiving a relationship input that associates two or more 3D models included in a 3D assembly, receiving a prompt input that includes a portion of text that describes the relationship input, causing a generative machine learning model to generate a design constraint based on the relationship input and the prompt input, and causing the 3D assembly to incorporate the design constraint.

2. The computer-implemented method of clause 1, wherein receiving the relationship input comprises receiving a selection of the two or more 3D models via an interaction within a graphical user interface that displays the 3D assembly.

3. The computer-implemented method of any of clauses 1-2, wherein receiving the relationship input comprises receiving a selection of a region of a design space, wherein the 3D assembly resides in the design space, and at least a portion of each of the two or more 3D models resides in the region.

4. The computer-implemented method of any of clauses 1-3, wherein receiving the prompt input comprises receiving the portion of text via a prompt space included in a graphical user interface that displays the 3D assembly.

5. The computer-implemented method of any of clauses 1-4, further comprising generating a relationship-constraint narrative based on the relationship input, the prompt input, and the design constraint, wherein the relationship-constraint narrative describes how the design constraint meets a condition set forth in the prompt input.

6. The computer-implemented method of any of clauses 1-5, further comprising generating a relationship-constraint narrative based on the relationship input, the prompt input, and the design constraint, wherein the relationship-constraint narrative indicates at least two options for implementing the design constraint, and receiving a selection that specifies a first option included in the at least two options.

7. The computer-implemented method of any of clauses 1-6, further comprising generating design context data based on the 3D assembly, wherein the design context data indicates at least one engineering specification associated with the 3D assembly, and wherein the design constraint is further generated based on the design context data.

8. The computer-implemented method of any of clauses 1-7, further comprising generating design context data based on the 3D assembly, wherein the design context data indicates at least one engineering specification associated with the 3D assembly, and generating a relationship-constraint narrative based on the relationship input, the prompt input, the design context data, and the design constraint, wherein the relationship-constraint narrative describes how the design constraint meets a condition set forth in the prompt input and the design context data.

9. The computer-implemented method of any of clauses 1-8, further comprising determining that at least one modification has already been made to the 3D assembly, wherein causing the 3D assembly to incorporate the design constraint comprises modifying the 3D assembly to cause the two or more 3D models to satisfy the design constraint.

10. The computer-implemented method of any of clauses 1-9, wherein the prompt input comprises a multi-model prompt that further includes at least a portion of an image.

11. Various embodiments include one or more non-transitory computer-readable media including instructions that, when executed by one or more processors, cause the one or more processors to generating three-dimensional (3D) assemblies by performing the steps of receiving a relationship input that associates two or more 3D models included in a 3D assembly, receiving a prompt input that includes a portion of text that describes the relationship input, causing a generative machine learning model to generate a design constraint based on the relationship input and the prompt input, and causing the 3D assembly to incorporate the design constraint.

12. The one or more non-transitory computer-readable media of clause 11, wherein the step of receiving the relationship input comprises receiving a selection of the two or more 3D models via an interaction within a graphical user interface that displays the 3D assembly.

13. The one or more non-transitory computer-readable media of any of clauses 11-12, wherein the step of receiving the relationship input comprises receiving a selection of a region of a design space, wherein the 3D assembly resides in the design space, and at least a portion of each of the two or more 3D models resides in the region.

14. The one or more non-transitory computer-readable media of any of clauses 11-13, wherein the step of receiving the prompt input comprises receiving a multi-model prompt that includes the portion of text via a prompt space included in a graphical user interface that displays the 3D assembly.

15. The one or more non-transitory computer-readable media of any of clauses 11-14, further comprising the step of generating a relationship-constraint narrative based on the relationship input, the prompt input, and the design constraint, wherein the relationship-constraint narrative describes how the design constraint meets a condition set forth in the prompt input.

16. The one or more non-transitory computer-readable media of any of clauses 11-15, further comprising the steps of generating a relationship-constraint narrative based on the relationship input, the prompt input, and the design constraint, wherein the relationship-constraint narrative indicates at least two options for implementing the design constraint, and receiving a selection that specifies a first option included in the at least two options.

17. The one or more non-transitory computer-readable media of any of clauses 11-16, further comprising generating design context data based on the 3D assembly, wherein the design context data indicates at least one engineering specification associated with the 3D assembly, and wherein the design constraint is further generated based on the design context data.

18. The one or more non-transitory computer-readable media of any of clauses 11-17, further comprising determining that the 3D assembly does not satisfy the design constraint, and determining a modification to the 3D assembly that causes the 3D assembly to satisfy the design constraint, wherein causing the 3D assembly to incorporate the design constraint comprises applying the modification to the 3D assembly to cause the 3D assembly to satisfy the design constraint.

19. The one or more non-transitory computer-readable media of any of clauses 11-18, further comprising determining an engineering standard based on the relationship input and the prompt input, wherein the design constraint is further generated based on the engineering standard.

20. Some embodiments include a system comprising one or more memories storing instructions, and one or more processors coupled to the one or more memories that, when executing the instructions, perform the steps of receiving a relationship input that associates two or more 3D models included in a 3D assembly, receiving a prompt input that includes a portion of text that describes the relationship input, causing a generative machine learning model to generate a design constraint based on the relationship input and the prompt input, and causing the 3D assembly to incorporate the design constraint.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating three-dimensional (3D) assemblies, the method comprising:
receiving a relationship input that associates two or more 3D models included in a 3D assembly;
receiving a prompt input that includes a portion of text that describes the relationship input;
causing a generative machine learning model to generate a design constraint based on the relationship input and the prompt input; and
causing the 3D assembly to incorporate the design constraint.

2. The computer-implemented method of claim 1, wherein receiving the relationship input comprises receiving a selection of the two or more 3D models via an interaction within a graphical user interface that displays the 3D assembly.

3. The computer-implemented method of claim 1, wherein receiving the relationship input comprises receiving a selection of a region of a design space, wherein the 3D assembly resides in the design space, and at least a portion of each of the two or more 3D models resides in the region.

4. The computer-implemented method of claim 1, wherein receiving the prompt input comprises receiving the portion of text via a prompt space included in a graphical user interface that displays the 3D assembly.

5. The computer-implemented method of claim 1, further comprising generating a relationship-constraint narrative based on the relationship input, the prompt input, and the design constraint, wherein the relationship-constraint narrative describes how the design constraint meets a condition set forth in the prompt input.

6. The computer-implemented method of claim 1, further comprising:
generating a relationship-constraint narrative based on the relationship input, the prompt input, and the design constraint, wherein the relationship-constraint narrative indicates at least two options for implementing the design constraint; and
receiving a selection that specifies a first option included in the at least two options.

7. The computer-implemented method of claim 1, further comprising generating design context data based on the 3D assembly, wherein the design context data indicates at least one engineering specification associated with the 3D assembly, and wherein the design constraint is further generated based on the design context data.

8. The computer-implemented method of claim 1, further comprising:
generating design context data based on the 3D assembly, wherein the design context data indicates at least one engineering specification associated with the 3D assembly; and
generating a relationship-constraint narrative based on the relationship input, the prompt input, the design context data, and the design constraint, wherein the relationship-constraint narrative describes how the design constraint meets a condition set forth in the prompt input and the design context data.

9. The computer-implemented method of claim 1, further comprising:
determining that at least one modification has already been made to the 3D assembly,
wherein causing the 3D assembly to incorporate the design constraint comprises modifying the 3D assembly to cause the two or more 3D models to satisfy the design constraint.

10. The computer-implemented method of claim 1, wherein the prompt input comprises a multi-model prompt that further includes at least a portion of an image.

11. One or more non-transitory computer-readable media including instructions that, when executed by one or more processors, cause the one or more processors to generating three-dimensional (3D) assemblies by performing the steps of:
receiving a relationship input that associates two or more 3D models included in a 3D assembly;
receiving a prompt input that includes a portion of text that describes the relationship input;
causing a generative machine learning model to generate a design constraint based on the relationship input and the prompt input; and
causing the 3D assembly to incorporate the design constraint.

12. The one or more non-transitory computer-readable media of claim 11, wherein the step of receiving the relationship input comprises receiving a selection of the two or more 3D models via an interaction within a graphical user interface that displays the 3D assembly.

13. The one or more non-transitory computer-readable media of claim 11, wherein the step of receiving the relationship input comprises receiving a selection of a region of a design space, wherein the 3D assembly resides in the design space, and at least a portion of each of the two or more 3D models resides in the region.

14. The one or more non-transitory computer-readable media of claim 11, wherein the step of receiving the prompt input comprises receiving a multi-model prompt that includes the portion of text via a prompt space included in a graphical user interface that displays the 3D assembly.

15. The one or more non-transitory computer-readable media of claim 11, further comprising the step of generating a relationship-constraint narrative based on the relationship input, the prompt input, and the design constraint, wherein the relationship-constraint narrative describes how the design constraint meets a condition set forth in the prompt input.

16. The one or more non-transitory computer-readable media of claim 11, further comprising the steps of:
generating a relationship-constraint narrative based on the relationship input, the prompt input, and the design constraint, wherein the relationship-constraint narrative indicates at least two options for implementing the design constraint; and
receiving a selection that specifies a first option included in the at least two options.

17. The one or more non-transitory computer-readable media of claim 11, further comprising generating design context data based on the 3D assembly, wherein the design context data indicates at least one engineering specification associated with the 3D assembly, and wherein the design constraint is further generated based on the design context data.

18. The one or more non-transitory computer-readable media of claim 11, further comprising:
determining that the 3D assembly does not satisfy the design constraint; and
determining a modification to the 3D assembly that causes the 3D assembly to satisfy the design constraint;
wherein causing the 3D assembly to incorporate the design constraint comprises applying the modification to the 3D assembly to cause the 3D assembly to satisfy the design constraint.

19. The one or more non-transitory computer-readable media of claim 11, further comprising determining an engineering standard based on the relationship input and the prompt input, wherein the design constraint is further generated based on the engineering standard.

20. A system comprising:
one or more memories storing instructions; and
one or more processors coupled to the one or more memories that, when executing the instructions, perform the steps of:
receiving a relationship input that associates two or more 3D models included in a 3D assembly,
receiving a prompt input that includes a portion of text that describes the relationship input,
causing a generative machine learning model to generate a design constraint based on the relationship input and the prompt input, and
causing the 3D assembly to incorporate the design constraint.
